(19) United States
(12) Patent Application Publication
(10) Pub. No.: US 2016/0234496 A1
(43) Pub. Date: Aug. 11, 2016

(54) NEAR VISUALLY LOSSLESS VIDEO RECOMPRESSION

(71) Applicant: QUALCOMM Incorporated, San Diego, CA (US)

(72) Inventors: Prasanjit Panda, San Diego, CA (US); Narendranath Malayath, San Diego, CA (US); Anush Krishna Moorthy, San Diego, CA (US); Mayank Tiwari, San Diego, CA (US)

(21) Appl. No.: 14/864,527

(22) Filed: Sep. 24, 2015

Related U.S. Application Data
(60) Provisional application No. 62/113,971, filed on Feb. 9, 2015.

(51) Int. Cl. H04N 19/124; H04N 19/40; H04N 19/44; H04N 19/85; H04N 19/426

(52) U.S. Cl. CPC H04N 19/124; H04N 19/85; H04N 19/428; H04N 19/44; H04N 19/40

(57) ABSTRACT

Techniques are described for performing near visually lossless video recompression. The disclosed techniques generate video frames having relatively small bitrates and relatively small file sizes while retaining approximately a same level of visually perceivable video quality as the originally recorded video frames. In general, recompression of a video frame takes an input video frame and produces a second copy of the video frame that has the same or lower Nitrate. The proposed techniques address the problem of recompressing a video frame with no perceivable loss in visual quality (i.e., visually lossless recompression) compared to the original recording of the video frame. In addition, the disclosed techniques provide one-step recompression of video frames that includes a single decoding and encoding of each video frame.

This application claims the benefit of U.S. Provisional Application No. 62/113,971, filed Feb. 9, 2015, the entire content of which is incorporated herein by reference.

### TECHNICAL FIELD

This disclosure relates to techniques for video compression.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T 11.264/MPEG-4, Part 10, Advanced Video Coding (AVC), ITU-T H.265, High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inte-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for performing near visually lossless video recompression. The disclosed techniques generate video frames having relatively small bitrates and relatively small file sizes while retaining approximately a same level of visually perceivable video quality as the originally recorded video frames. In general, recompression of a video frame takes an input video frame and produces a second copy of the video frame that has the same or lower bitrate. The proposed techniques, referred to herein as “VZIP,” address the problem of recompressing a video frame with no perceivable loss in visual quality (i.e., visually lossless recompression) compared to the original recording of the video frame. In addition, the disclosed techniques provide one-step recompression of video frames that includes a single decoding and encoding of each video frame.

In one example, this disclosure is directed to a method of processing video data. The method comprises storing a plurality of precomputed quantization parameter (QP) values, wherein the plurality of precomputed QP values are precomputed based on a database of video clips and a quality metric to determine maximum QP values used to recompress each of the video clips that result in no visually perceivable loss in video quality; obtaining a video frame at a first bitrate; determining a complexity value for the video frame based on spatial, temporal, and coding statistics associated with the video frame; selecting a QP value from the plurality of precomputed QP values based on the complexity value for the video frame; and recompressing the video frame in accordance with the selected QP value from the first bitrate to a second bitrate with no visually perceivable loss in video quality, the second bitrate being lower than the first bitrate.

In another example, this disclosure is directed to a video processing device, the device comprising a memory and one or more processors in communication with the memory. The memory is configured to store a plurality of precomputed QP values, wherein the plurality of precomputed QP values are precomputed based on a database of video clips and a quality metric to determine maximum QP values used to recompress each of the video clips that result in no visually perceivable loss in video quality. The one or more processors and configured to obtain a video frame at a first bitrate; determine a complexity value for the video frame based on spatial, temporal, and coding statistics associated with the video frame; select a OP value from the plurality of precomputed QP values based on the complexity value for the video frame; and recompress the video frame in accordance with the selected QP value from the first bitrate to a second bitrate with no visually perceivable loss in video quality, the second bitrate being lower than the first bitrate.

In a further example, this disclosure is directed to a video processing device, the device comprising means for storing a plurality of precomputed QP values, wherein the plurality of precomputed QP values are precomputed based on a database of video clips and a quality metric to determine maximum QP values used to recompress each of the video clips that result in no visually perceivable loss in video quality; means for obtaining a video frame at a first bitrate; means for determining a complexity value for the video frame based on spatial, temporal, and coding statistics associated with the video frame; means for selecting a QP value from the plurality of precomputed QP values based on the complexity value for the video frame; and means for recompressing the video frame in accordance with the selected QP value from the first bitrate to a second bitrate with no visually perceivable loss in video quality, the second bitrate being lower than the first bitrate.

In an additional example, this disclosure is directed to anon-transitory computer-readable medium storing instructions that, when executed, cause one or more processors to store a plurality of precomputed QP values, wherein the plurality of precomputed QP values are precomputed based on a database of video clips and a quality metric to determine maximum QP values used to recompress each of the video clips that result in no visually perceivable loss in video quality; obtain a video frame at a first bitrate; determine a complexity value for the video frame based on spatial, temporal, and coding statistics associated with the video frame; select a QP value from the plurality of precomputed QP values based on the complexity value for the video frame; and recompress the video frame in accordance with the selected QP value from the first bitrate to a second bitrate with no visually perceivable loss in video quality, the second bitrate being lower than the first bitrate.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may he used to implement techniques of this disclosure for recompressing, encoding, and/or transcoding video data.

FIG. 2 is block diagram illustrating an example video recompression unit that may implement the techniques described in this disclosure.

FIG. 3 is a block diagram illustrating an example lookup table (LUT) generation system that may be used to generate a re-encode complexity (REC) model, in accordance with the techniques described in this disclosure.

FIG. 4 is a block diagram illustrating an example use case of video recompression for storage compaction.

FIG. 5 is a block diagram illustrating an example use case of video recompression for video sharing.

FIG. 6 is a block diagram illustrating an example use case of video recompression for live video recordings.

FIG. 7 is a graph illustrating example rate-distortion curves for different video clips having different quality levels at a given bitrate.

FIG. 8 is a graph illustrating example performance levels of the video recompression techniques described in this disclosure.

FIG. 9 is a flowchart illustrating an example operation of the video recompression techniques described in this disclosure.

### DETAILED DESCRIPTION

This disclosure describes techniques for performing near visually lossless video recompression. The disclosed techniques generate video frames having relatively small bitrates and relatively small file sizes while retaining approximately a same level of video quality as the originally recorded video frames. In general, recompression of a video frame takes an input video frame and produces a second copy of the video frame that has the same or lower bitrate. The proposed techniques, also referred to as “VZIP,” address the problem of recompressing a video frame with no perceivable loss in visual quality (i.e., visually lossless recompression) compared to the original recording of the video frame.

Video recordings at higher resolutions, frame rates and bitrates generate large video clips. For example, every minute of 4K30 (4K, 30 frames per second) video recorded at 50 mops adds 375 MB of data, which can quickly fill up the memory on a device. In addition, large video clips are difficult to upload to websites and servers. This is especially true on mobile devices where memory and wireless channel bandwidth is at a premium.

Simple transcoding may he used to reduce the bitrate of a video frame, but the additional constraint addressed by the disclosed techniques is to maintain visual fidelity of the video content. Furthermore, the disclosed techniques provide one-step recompression of video frames that includes a single decoding and encoding of each video frame. In this way, multiple iterations in the decoding or encoding of the video frames are not necessary. In other examples, instead of changing a video bitrate, the resolution, frame rate, coding standard, or other video codec features may be changed while maintaining visual fidelity.

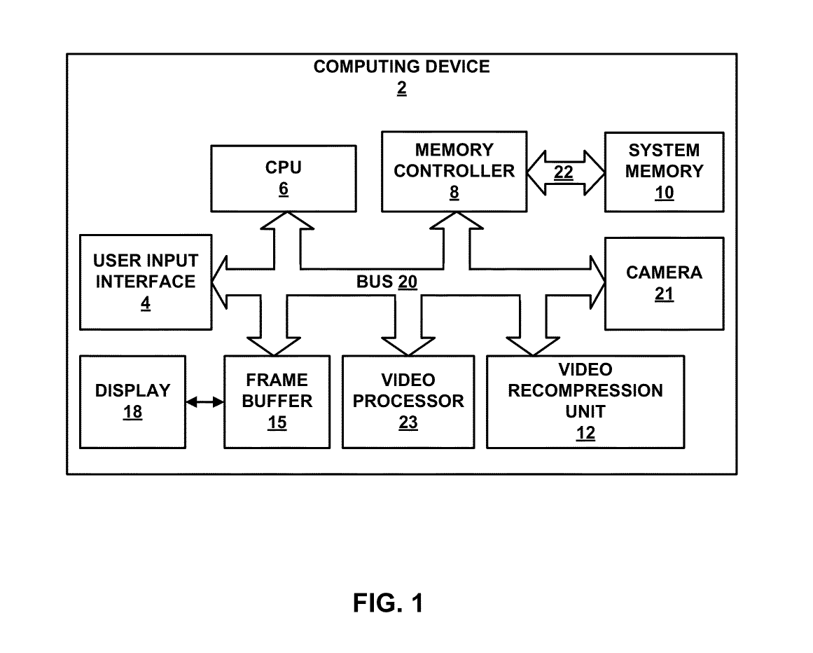

FIG. 1 is a block diagram illustrating an example computing device 2 that may be used to implement techniques of this disclosure for recompressing, encoding, and/or transcoding video data. Computing device 2 may comprise, for example, a personal computer, a desktop computer, a laptop computer, a tablet computer, a computer workstation, a video game platform or console, a wireless communication device, a mobile telephone such as, e.g., a cellular or satellite telephone, a landline telephone, an Internet telephone, a digital camera, an Internet-connected camera, a handheld device such as a portable video game device or a personal digital assistant (PDA), a personal music player, a video player, a display device, a television, a television set-top box, a server, an intermediate network device, a mainframe computer, any mobile device, or any other type of device that processes and/or displays video and/or image data.

As illustrated in the example of FIG. 1, computing device 2 may include user input interface 4, central processing unit (CPU) 6, memory controller 8, system memory 10, video recompression unit 12, display 18, buses 20 and 22, camera 21, and video processor 23. In some cases, CPU 6, memory controller 8, video recompression unit 12, and video processor 23 shown in FIG. 1 may be on-chip, for example, in a system on a chip (SoC) design. User input interface 4, CPU 6, memory controller 8, and video recompression unit 12 may communicate with each other using bus 20. Memory controller 8 and system memory 10 may also communicate with each other using bus 22. In examples where computing device 2 comprises a wireless communication device, computing device 2 may also include a wireless communication interface (not shown).

Buses 20, 22 may be any of a variety of bus structures, such as a third generation bus (e.g., a HyperTransport bus or InfiniBand bus), a second generation bus (e.g., an Advanced Graphics Port bus, a Peripheral Component Interconnect (PCI) Express bus, or an Advanced eXentisible interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. The user may provide input to computing device 2 via one or more input devices (not shown) such as a keyboard, a mouse, a microphone, a touch pad or another input device that is coupled to computing device 2 via user input interface 4.

Memory controller 8 facilitates the transfer of data going into and out of system memory 10. For example, memory controller 8 may receive memory read and write commands, and service such commands with respect to system memory 10 in order to provide memory services for the components in computing device 2. Memory controller 8 is communicatively coupled to system memory 10 via memory bus 22. Although memory controller 8 is illustrated in FIG. 1 as being a processing module that is separate from both CPU 6 and system memory 10, in other examples, some or all of the functionality of memory controller 8 may be implemented on one or both of CPU 6 and system memory 10.

System memory 10 may store program modules and/or instructions that are accessible for execution by CPU 6 and/or data for use by the programs executing on CPU 6. In addition, system memory 10 may store video data encoded by video processor 23. Furthermore, system memory 10 may be configured to store video data that has been recompressed by video recompression unit 12 in accordance with the techniques of this disclosure. System memory 10 may store a window manager application that is used by CPU 6 to present a graphical user interface (GUI) on display 18. In addition, system memory 10 may store user applications and application surface data associated with the applications. System memory 10 may additionally store information for use by and/or generated by other components of computing device 2. System memory 10 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data media or an optical storage media.

In general, video processor 23 may be configured to encode and decode video data. For example, video processor 23 may be configured to encode video stored in system memory 10. In addition, video processor 23 may be configured to encode video data from pixel values produced by camera 21, CPU 6, and/or another source of video data (e.g., a graphics processing unit (GPU)). As will be explained in more detail below, video processor 23 may be configured to encode and/or transcode video data in accordance with the techniques of this disclosure.

Video processor 23 may be configured to encode and decode video data according to a video compression standard, such as the ITU-T H.265, High Efficiency Video Coding (HEVC), standard. The HEVC standard document is published as ITU-T H.265, Series H: Audiovisual and Multimedia Systems, infrastructure of audiovisual services—Coding of moving video, High efficiency video coding, Telecommunication Standardization Sector of International Telecommunication Union (ITU), April 2015. The techniques described in this disclosure may also operate according to extensions of the HEVC standard. Alternatively or additionally, video processor 23 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

In general, the HEVC standard describes that a video frame or picture may be divided into a sequence of treeblocks or largest coding units (LCU) that include both luma and chroma samples. Syntax data within bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list for the motion vector.

A leaf-CU having one or more PUs may also include one or more transform units (TUs). The transform units may be specified using an RQT (also referred to as a TV quadtree structure), as discussed above. For example, a split flag may indicate whether a leaf-CU is split into four transform units. Then, each transform unit may be split further into further sub-TUs. When a TU is not split further, it may he referred to as a leaf-TV. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video processor 23 typically operates on video blocks within individual video slices in order to encode the video data. A video block may correspond to a coding node within a CU. The video blocks may have fixed or varying sizes, and may differ in size according to a specified coding standard.

As an example, the HEVC standard supports prediction in various PU sizes. Following intra-predictive or inter-predictive coding using the PUs of a CU, video processor 23 may calculate residual data for the TUs of the CU. The PUs may comprise syntax data describing a method of mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video processor 23 may form the TUs including the residual data for the CU, and then transform the TUs to produce transform coefficients for the CU.

Following any transforms to produce transform coefficients, video processor 23 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video processor 23 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video processor 23 may utilize a predefined scan order to scan the quantized transform coefficients to produce a serialized vector that can be entropy encoded. In other examples, video processor 23 may perform an adaptive scan.

After scanning the quantized transform coefficients to form a one-dimensional vector, video processor 23 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video processor 23 may also entropy encode syntax elements associated with the encoded video data for use by a video decoder in decoding the video data.

Camera 21 may include a lens and a camera sensor configured to detect light and generate color pixel values (e.g., RGB values). Camera 21 may further include an image signal processor. In some examples, the image signal processor will be included together in the same package as the lens and camera sensor. In other examples, the image signal processor may be packaged separately from the lens and camera sensor. The image signal processor may be configured to receive the raw sensor data, convert the raw sensor data to a compressed data format (e.g., a JPEG file) and store the resultant compressed data in a picture file. In other examples, the image signal processor may be configured to retain the raw sensor data and save the raw sensor data in a separate file.

In other examples, camera 21 may be configured to capture video. In this example, camera 21 may provide the video data captured by the image sensor to video processor 23. Video processor 23 may be configured to compress/encode the captured video data according to a video compression standard, such as the video compression standards mentioned above.

In another example of the disclosure, camera 21 may form part of a connected-camera (or Internet-connected camera) in conjunction with one or more other components of computing device 2. When configured as a connected camera, computing device 2 (including camera 21) may be configured to both capture video data as well as stream the captured video data (with a wired or wireless connection) to one or more other network-connected devices.

CPU 6, camera 21, and/or video processor 23 may store video data in a frame buffer 15. Frame buffer 15 may be an independent memory or may be allocated within system memory 10. A display interface may retrieve the data from frame buffer 15 and configure display 18 to display the image represented by video data. In some examples, the display interface may include a digital-to-analog converter (DAC) that is configured to convert the digital values retrieved from the frame buffer into an analog signal consumable by display 18. In other examples, a display interface may pass the digital values directly to display 18 for processing. Display 18 may include a monitor, a television, a projection device, a liquid crystal display (LCD), a plasma display panel, a light emitting diode (LED) array, such as an organic LED (OLED) display, a cathode ray tube (CRT) display, electronic paper, a surface-conduction electron-emitted display (SED), a laser television display, a nanocrystal display or another type of display unit. Display 18 may be integrated within computing device 2. For instance, display 18 may be a screen of a mobile telephone. Alternatively, display 18 may be a stand-alone device coupled to computing device 2 via a wired or wireless communications link. For instance, display 18 may be a computer monitor or flat panel display connected to a personal computer via a cable or wireless link.

Video recompression unit 12 is configured to direct and cause the recompression, encoding, and/or transcoding of video data. In accordance with the techniques of this disclosure, video recompression unit 12 may be configured to determine a bitrate at which to recompress, encode and/or transcode video data such that the final bitrate of the recompressed, encoded, and/or transcoded video data is at a lower bitrate than the original video data. In one example of the disclosure, video recompression unit 12 may be configured to determine a final bitrate at which to recompress/encode/transcode video data such that the resultant video appears to be, or very closely appears to be, lossless compared to the original video data. Video recompression unit 12 may be configured to determine the bitrate and other encoding parameters and instruct video processor 23 to transcode and/or encode video data according to the determined parameters. Video recompression unit 12 may be configured as software executing on a processor (e.g., CPU 6, a graphics processing unit, a digital signal processor, etc.), as firmware executing on a processor, as dedicated hardware, or as any combination of the above.

As will be discussed in more detail below, the transcoding and encoding techniques of this disclosure may result in transcoded video data that is smaller in size (i.e., in terms of the number of bits) than the original video data while still maintaining high visual quality. Accordingly, longer lengths of high resolution video (e.g., HD video, 1080P, 1080i, 4k, etc.) may be stored on storage-limited mobile devices (e.g., smartphones, tablet computers, laptop computers, connected cameras etc.). In addition, the time it takes to upload and/or transmit high resolution video on bandwidth-limited mobile devices (e.g., smartphones, tablet computers, laptop computers, connected cameras etc.) may be decreased.

Several issues related to recording, storing and transmitting video files using mobile devices will now be described. High definition video data, including so-called 4K video data, often results in very large file sizes. The longer the video, the larger the amount of storage that is needed to store the video. Similarly, connected-cameras producing 4k60 (4 k, 60 frames per second) data may produce video files of a very large size. For example, 4 k video produced according to the H.264 video compression standard typically uses a bit rate of 48 mbps (megabits per second). One second of H.264 4K video at 48 mbps uses 6 MB of storage space. One minute of H.264 4K video at 48 mpbs uses 360 MB of storage space. One hour of H.264 4K video at 48 mpbs uses 21.6 GB of storage space. Many mobile devices only have 16 GB of storage or less. As such, the storage of 4K video at long lengths may be difficult or even impossible on many devices.

Similarly, transferring such large video files off of a mobile device may also be difficult. Such large file sizes result in a very long upload time when using a conventional wireless service (e.g., 4G or LTE). Furthermore, wireless services for mobile devices are often limited in terms of the amount of bandwidth that is available to a user per month. Accordingly, the upload of large video files becomes less feasible.

In view of these drawbacks, this disclosure proposes video recompression, encoding and transcoding techniques that allow for the creation of smaller video files, with minimal loss of visual quality, in order to alleviate storage and upload uses cases.

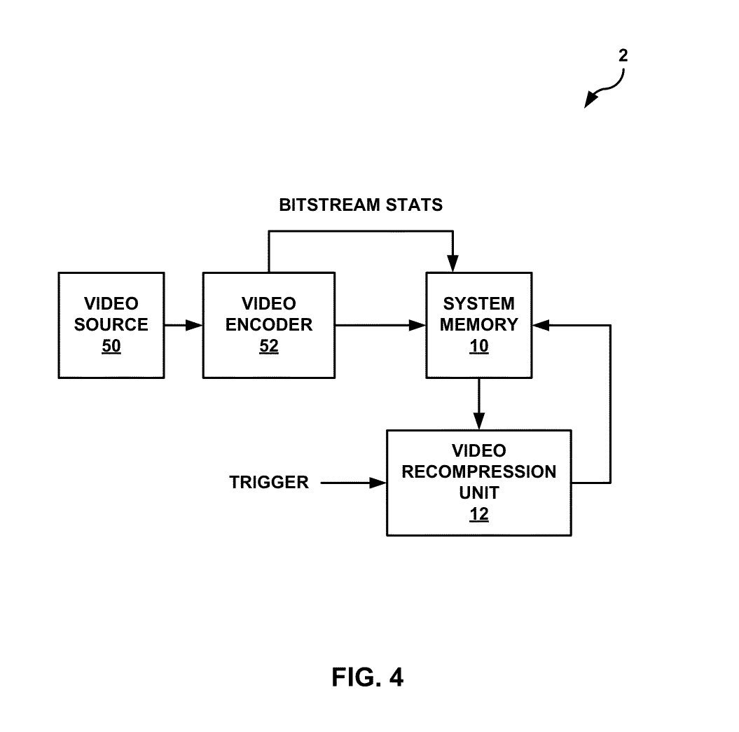

Table 1, below, outlines various use cases for the techniques of this disclosure. The use cases included in Table 1 are described in more detail with respect to FIGS. 4-6, respectively.

TABLE 1

| | | What is | |
|---|---|---|---|
| Use Case | Issues | being done | Impact |
| Storage | Quickly fills | Record fewer, | Limited |
| Compaction | up storage | shorter | usage of |
| | | videos | premium feature |
| Video | Difficult to share: | Video | Poor quality |
| Sharing | 1. Long time | transcoded | videos |
| | to upload | to lower | |
| | 2. High data | resolution, | |
| | usage cost | frame rate, | |
| | | or bitrate | |
| Live Video | 1. Quickly fills | Video | 1. Limited |
| Recording | up storage | transcoded | usage of |
| | 2. Poor quality | to lower | premium feature |
| | of video | resolution, | 2. Poor |
| | 3. Needs to be | frame | quality videos |
| | done live | rate, or | |
| | | bitrate | |

As one example, limited memory available on mobile devices may result in storage compaction issues. That is, mobile devices quickly run out of memory when attempting to store 4K or other HD videos. Currently, users of mobile devices are limited to recording fewer, shorter videos. This limits the usage of a premium feature of the mobile device (i.e., the ability to encode and decode HD and 4K videos). The recompression techniques of this disclosure (also referred to as “VZIP”) may be used to encode, recompress and/or transcode video data to create smaller file sizes.

As another use case, the techniques of this disclosure may be used for the sharing and uploading of video data. Currently, large video files take a long time to upload. In addition, there are often high data usage costs associated with uploading large files. Currently, videos are transcoded to lower resolutions, frame rates (i.e., frames per second (fps)), and bitrates to alleviate problems related to video uploads. However, current solutions result in poor quality videos. The techniques of this disclosure allow for encoding/transcoding/recompression of video files at a lower bitrate with minimal loss of video quality.

As another use case, the techniques of this disclosure may be used for video streaming (e.g., with connected cameras). Current video streaming devices quickly fill up storage when recording in HD and/or 4 k. In addition, the quality of video that is streamed is poor, as the streamed video is typically encoded at a low visual quality in addition to a low bit rate. Again, the techniques of this disclosure allow for transcoding/recompression of video files at a lower bitrate with minimal loss of video quality.

in general, the techniques of this disclosure involve one or more of recompression of video, the recompression of video for further transcoding, 1-pass compression (encoding) of video for live streaming, and/or 1-pass compression (encoding) of video for recording (e.g., storage) and streaming.

Video recompression unit 12 may be configured to control video processor 23 to recompress, encode, and/or transcode video data at a lower bitrate. In this context, a lower bitrate is a bitrate that is lower than the original video data or a bitrate that is lower than what would typically be used for HD and/or 4K video (e.g., a bitrate prescribed by the techniques of a video compression standard). In particular, video recompression unit 12 may be configured to recompress/encode/transcode video data at a lower bit rate in a way that results in only a minimal loss of visual quality. A discussion of an example rate control process for video coding is described below.

In one example, the frame of an original video sequence is partitioned into rectangular regions or blocks, which may be encoded in Intra-mode (I-mode) or Inter-mode (P-mode or B-mode). The blocks are coded using some kind of transform coding, such as DCT coding. However, pure transform-based coding only reduces the inter-pixel correlation within a particular block, without considering the inter-block correlation of pixels. Transform-based coding still produces high bitrates for transmission. Current digital image coding standards, such as HEVC, also exploit certain methods that reduce the correlation of pixel values between blocks.

In general, blocks encoded in P-mode are predicted from one of the previously coded and transmitted frames. The prediction information of a block is represented by a two-dimensional (2D) motion vector. For the blocks encoded in I-mode, the predicted block is formed using spatial prediction from already encoded neighboring blocks within the same frame. The prediction error E(x, y), i.e., the difference between the block being encoded l(x, y) and the predicted block P(x, y), is represented as weighted sum of a transform basis functions ƒᵢⱼ(i, j):

$$E ( x , y ) = {\sum }_{i = 0}^{N - 1} {\sum }_{j = 0}^{N - 1} {c}_{ij} {f}_{ij} ( i , j ) \qquad ( 1 )$$

The transform is typically performed on an 8×8 (N=8) or 4×4 (N=4) block basis. The weights cᵢⱼ, called prediction error coefficients, are subsequently quantized:

lᵢⱼ=Q(cᵢⱼ, QP), (2)

where lᵢⱼ are called the quantized coefficients or levels. The operation of quantization introduces loss of information. On the other hand, the quantized coefficient can be represented with smaller number of bits. The level of compression (loss of information) is controlled by adjusting the value of the quantization parameter (QP). A lower QP value typically results in less distortion, but may require more bits, and thus a higher bitrate. A higher QP value typically results in more distortion, but may require fewer bits, and thus a lower bitrate. As such, the selection of the QP is one technique whereby a tradeoff between distortion and bit rate may be made.

Quantized transform coefficients, together with motion vectors and some control information, form a complete coded sequence representation, and are referred to as syntax elements. Prior to transmission from video encoder to video decoder, syntax elements may be entropy coded so as to further reduce the number of bits needed for their representation.

At a video decoder, the reconstructed block in the current frame is obtained by first constructing its prediction in the same manner as performed by a video encoder, and by adding the compressed prediction error to the prediction. The compressed prediction error is found by using the de-quantized coefficients by performing an inverse transform as follows:

$$\tilde{E} ( x , y ) = {\sum }_{i = 0}^{N - 1} {\sum }_{j = 0}^{N - 1} {r}_{ij} {\tilde{f}}_{ij} ( i , j ) \qquad ( 3 )$$

The dequantized (also called reconstructed) coefficients rᵢⱼ are calculated by the inverse quantization as follows:

rᵢⱼ=Q⁻¹(lᵢⱼ, QP) (4)

The difference between the reconstructed frame R(x, y) and the original frame l(x, y) is called reconstruction error.

The HEVC standard leaves decisions regarding quantization, selection of the motion vectors, and which frame should be used for prediction, to the implementer of a video encoder. Rate-distortion theory formalizes the lossy compression goal into that of minimizing coding distortion, which is a measure of distance between the original and the compressed data according to a chosen metric, subject to a constraint in the rate for coding the data. Thus, in some examples, a goal of a video encoder is to find, for each frame, values of syntax elements such that the mean-squared-error (MSE) distortion D between the prediction error E(x, y) and the reconstructed version of the prediction error \tilde{E}(x, y) is minimized subject to a constraint in the rate R for coding the syntax elements:

min[D(E(x, y)−\tilde{E}(x, y))] subject to R<R_{budget}. (5)

Other additive distortion metrics can be used instead of MSE, such as, e.g., activity-weighted MSE. The rate-constrained problem in equation (5) can be solved by being converted to an equivalent unconstrained problem by “merging” rate and distortion through the Lagrange multiplier λ. In this disclosure, the Lagrange multiplier λ will be referred to as the rate control parameter. The unconstrained problem becomes the determination (for a fixed λ) of values of syntax elements, which results in the minimum total Lagrangian Cost defined as:

j(λ)=D(E(x, y)−\tilde{E}(x, y))+λR. (6)

The rate control parameter λ can be viewed as a parameter used to determine a trade-off between rate and distortion. A low value of λ favors minimizing distortion over rate, and a high value of λ favors minimizing rate aver distortion. At the limits, λ=0, distortion is minimized; λ→∞, rate is minimized.

As can be seen from the above-discussion, one technique for reducing the bitrate of a video sequence, while also introducing some loss, is to increase the value of the QP. In accordance with the techniques of this disclosure, video recompression unit 12 may be configured to instruct video processor 23 to encode/transcode video data using a higher QP value than what would have been used, or had been used, to originally encode HD and/or 4 k video. In one example, of the disclosure, video recompression unit 12 may be configured to determine a QP value to use for encoding/transcoding video data using a lookup table that is pre-stored on computing device 2. The lookup table may indicate the amount of loss in visual quality for the video data for a plurality of different QP values. The loss in visual quality metrics in the lookup table may be based on other characteristics of the video data, including the frame rate, the resolution, and the complexity of the video data.

Video recompression unit 12 may be configured to determine a QP value to use for encoding/transcoding such that the resultant loss in video quality is below some threshold. In one example, the threshold may be called a perceived visual lossless threshold and may be based on a perceived visual quality metric. The perceived visual lossless threshold and the perceived visual quality metric may be pre-determined so that they represent an amount of loss of visual quality that is undetectable and/or barely detectable to the human eye. In other examples, the perceived visual lossless threshold and the perceived visual quality metric may be pre-determined such they represent an amount of loss of visual quality that is acceptable to an average user given the expectations of HD and/or 4K video. Video recompression unit 12 may be configured to select a QP value, and hence a degree of quantization, such that the resultant loss in visual quality is still below the perceived visual lossless threshold.

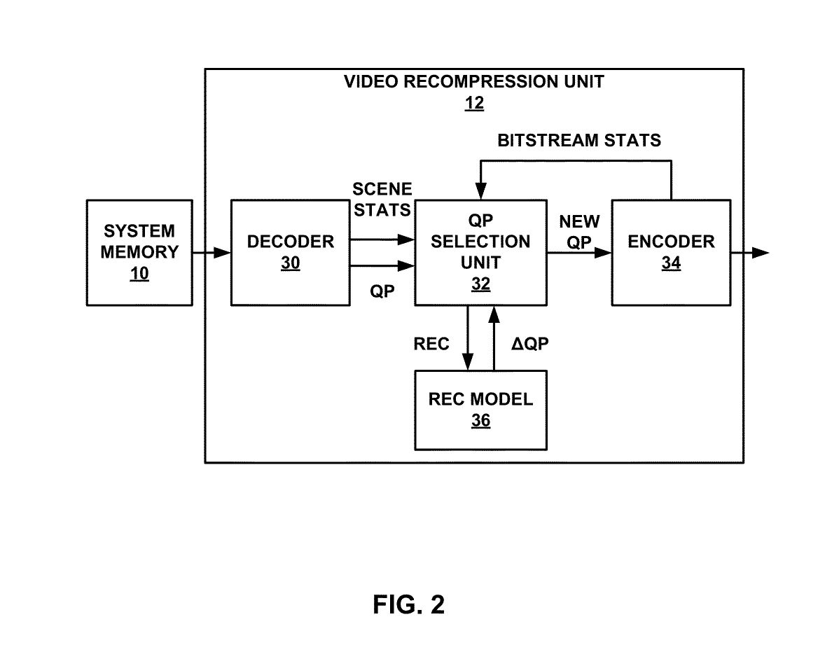

FIG. 2 is block diagram illustrating an example of video recompression unit 12 from FIG. 1 that may implement the techniques described in this disclosure. In general, video recompression unit 12 is configured to recompress video clips with no perceivable loss in visual quality in a single step. Furthermore, video recompression unit 12 is configured to provide one-step recompression of video clips that includes a single decoding and encoding of each frame of the video clips such that there are no iterations in the decoding or encoding of the frames. Near visually lossless recompression may be defined as recompression resulting in video clips that look the same to the human eye at regular playback speeds. More specifically, near visually lossless recompression may be measured based on a visually lossless threshold defined for a corresponding video quality metric.

The disclosed recompression techniques result in video frames having a same or lower bitrate. In some examples, other video clip parameters, such as resolution, frame rate, coding standard and other video codec features, may be changed to achieve near visually lossless compression. Video clips may be encoded in any video standard that uses a quantization parameter/step/index/value (including but not limited to HEVC, H.264, MPEG-4, MPEG-2, H.263, VC-1) or a proprietary codec (including but not limited to VP9, VP8).

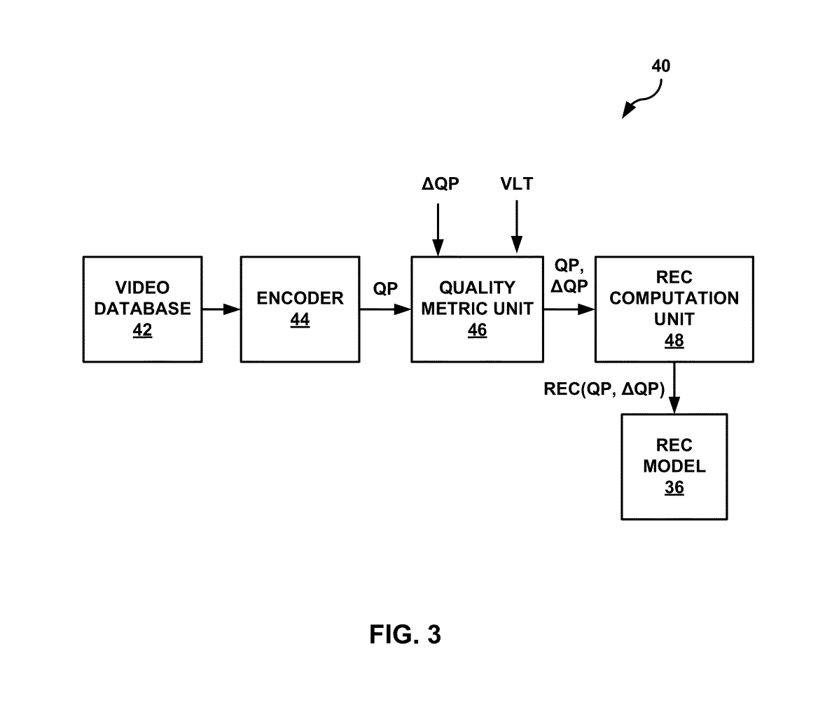

In the illustrated example of FIG. 2, video recompression unit 12 includes a decoder 30, a QP selection unit 32, an encoder 34, and a re-encode complexity (REC) model 36. In general, the disclosed recompression techniques include an online stage and an offline stage. For example, video recompression unit 12 may perform online recompression of video frames based on REC model 36, which is generated offline. The offline generation of REC model 36 is described in more detail below with respect to FIG. 3.

In accordance with the recompression techniques described in this disclosure, decoder 30 retrieves video frame encoded at a first bitrate (e.g., 48 mbps for 4K video) from system memory 10 and decode the video frame. Decoder 30 may record a QP value of the decoded video frame, and pass the decoded video frame to a YUV statistics computation library that extracts scene statistics that characterize the scene. Decoder 30 then sends the scene statistics (e.g., YUV statistics) associated with the decoded video frame and the QP value for the decoded video frame to QP selection unit 32. QP selection unit 32 selects a new QP value used to recompress the video frame at a lower second bitrate with no visually perceivable loss in video quality. Video encoder 34 may then encode the video frame in accordance with the selected QP value at the second bitrate.

The visually lossless compression described herein is enabled based on two sets of statistics: (1) YUV or scene statistics from the decoded video frames in a YUV buffer and (2) bitstream statistics (sometimes referred to as Venus statistics) from encoder macroblock information (MBI). The bitstream statistics are encoding statistics and may include such video characteristics as frame rate (e.g., fps), complexity, QP, bitrate, coding mode, and the like. QP selection unit 32 combines the bitstream statistics with the scene statistics to select a visually lossless QP value based on the QP value for the decoded video frame. The video frame is then recompressed with this estimated QP. The re-encoded video frame may be parsed for its MBI and the encoded bitstream statistics are computed and fed back to QP selection unit 32. Video recompression unit 12 operates with rate control turned off since the disclosed techniques select new QP values on a frame-by-frame basis.

QP selection unit 32 may select the new QP value for recompression of the video frame from precomputed QP values stored as REC model 36. For example, QP selection unit 32 of video recompression unit 12 may determine a REC value or recompression statistic for the video frame based on the scene statistics (e.g., YUV statistics) associated with the video frame from video decoder 30 and the bitstream statistics associated with a previously encoded video frame from video encoder 34.

In this way, the REC value may be generated using spatial, temporal, and coding statistics generated from raw picture information (e.g., YUV or scene statistics) as well as information gathered during the encoding of previous frames of the video clip (e.g., bitstream statistics). In one example, raw picture information may include a texture measure, luminance measure, and temporal measure corresponding to three perceptual features, namely texture masking, luminance masking, and temporal masking. In this example, coding complexity statistics may include spatial and motion complexity measures derived from the information gathered during the encoding process. The recompression statistic may then be derived as a combination of the individual spatial, temporal, and coding statistics by using methods including but not limited to composition by taking the product of individual measures, pooling, or Scalar Vector Machines (SVM).

QP selection unit 32 selects the QP value from REC model 36 based on the REC value determined for the video frame. REC model 36 may map the REC value or recompression statistic to a maximum QP value for near visually lossless recompression. REC model 36 may be implemented in several ways including using a lookup table (LUT) or a function. In one example, REC model 36 may comprise a delta QP LUT indexed by REC values for video frames at given QP values. In another example, REC model 36 may comprise a function that returns a delta QP value based on REC values for video frames at given QP values. QP selection unit 32 then calculates the new QP value at which to recompress the video frame based on the delta QP value and the previous QP value for the video frame.

In the example illustrated in FIG. 2, the near visually lossless video recompression techniques of this disclosure performs the following: decode a video clip, generate a recompression statistic (e.g., REC value), use the mapping from the recompression statistic to QP values (e.g., REC model 36) to find the highest QP value that generates a recompressed video clip that is visually lossless, and re-encode the video clip. In other examples, the near visually lossless video recompression techniques of this disclosure may perform one or more of the following: remove the need to decode a video clip and instead directly apply the video recompression techniques to raw video, generate multiple recompressed video clips at different resolutions, frame rates and bitrates, or perform compression frame-by-frame rather than on the whole clip.

FIG. 3 is a block diagram illustrating an example LUT generation system 40 that may be used to generate REC model 36, in accordance with the techniques described in this disclosure. In general, REC model 36 may be generated to map REC values for a video clip to a highest delta QP value that can be used to re-encode the video clip with no visually perceivable loss in video quality. LUT generation system 40 may be external to and separate from video recompression unit 12 and computing device 2. REC model 36 may be generated by LUT generation system 40 offline. In the example of FIG. 3, REC model 36 is described as being implemented as a LUT. In other examples, REC model 36 may be implemented as a mathematical function.

In the example illustrated in FIG. 3, LUT generation system 40 includes a video database 42, an encoder 44, a quality metric unit 46, and a REC computation unit 48. REC model 36 may be generated according to a training method based on video database 42 that includes a plurality of video clips. In one example, each video clip in video database 42 may be encoded by encoder 44 at a certain original QP value (e.g., 0-51 for H.264). Quality metric unit 46 then recompresses the video clip at a range of QP values and measures a quality metric of the recompressed video clip at each of the QP values. Typically, only QP values greater than the original QP value for the video clip (i.e., non-zero delta QP values) are used in the training method. In this way, quality metric unit 46 may determine the highest QP value at which the video clip can be re-encoded with no visual perceivable loss in video quality for the given content and original QP value of the video clip.

Quality metric unit 46 may measure visual quality of the video clip recompressed at each QP value using many different video quality metrics, including but not limited to objective video quality metrics like video quality metric (VQM), visual information fidelity (VIF), structural similarity (SSIM) and its variants, quantization parameter step size (QSTEP), and peak signal-to-noise ratio (PSNR)/mean-squared-error (MSE). Quality metric unit 46 may then compare the quality metric against a visually lossless threshold (VLT) defined for the quality metric. Assuming the video quality metric increases as video quality increases, a recompressed video clip may be determined to be visually lossless if the quality metric of the recompressed video clip is greater than or equal to the VLT. In one example, the VLT may be determined using subjective testing using a Double Stimulus Continuous Quality Scale (DSCQS) method.

REC computation unit 48 may use spatial, temporal, and coding statistics derived for the video clip to generate the REC value for the video clip at the determined highest QP value. From all of the data generated by these steps, REC model 36 is generated for every QP value that includes the mean and variance of the REC values or recompression statistics for the range of QP values. In this way, REC model 36 includes a plurality of precomputed QP values that may be used by video recompression unit 12 to determine a maximum QP value at which to recompress a video frame with no visually perceivable loss in video quality.

FIG. 4 is a block diagram illustrating an example use case of video recompression for storage compaction performed by video recompression unit 12 of computing device 2 from FIG. 1. In the storage compaction use case illustrated in FIG. 4, video recompression unit 12 of computing device 2 may be configured to recompress a video frame originally encoded at a higher first bitrate and stored at a first file size to a lower second bitrate (i.e., lower than the first bitrate) for storage at a second file size that is smaller than the first file size. In some examples, the second bitrate may be 30-70% lower than the first bitrate, and the second file size may be 30-70% smaller than the first file size.

In the example illustrated in FIG. 4, a video encoder 52 receives raw video frames from a video source 50, encodes the video frames at the higher first bitrate (e.g., 48 mbps), and stores the video frames in system memory 10. Video encoder 52 may also store bitstream statistics associated with the encoded video frames in system memory 10. In some examples, video encoder 52 may comprise an encoder portion of video processor 23 of computing device 2. Video source 50 may comprise camera 21 of computing device 2 or an external camera.

According to the disclosed techniques, recompression of a video frame may be triggered by a trigger condition identified by video recompression unit 12. For example, the trigger condition may comprise a characteristic of the computing device 2, such as expiration of a preset or periodic timer, detection of low usage times (e.g., overnight), or detection that computing device 2 is plugged in. The trigger condition may also comprise a user input to computing device 2, such as a user explicitly selecting when to perform recompression, or a user requesting to share, upload, or stream the video frame using a certain application or “app” executed on computing device 2. In some examples, the recompression of the stored video frames may be performed automatically for all video files in the background so as to impose minimal impact on a user experience. For example, all newly recorded video files may be recompressed each night when computing device 2 is plugged in and charging.

Upon identifying the trigger condition, video recompression unit 12 obtains a video frame to be recompressed. As described above, video recompression unit 12 may be configured to decode the video frame encoded at the first bitrate, select a new QP value at which to recompress the video frame such that the recompressed video frame is nearly visually lossless compared to the original video frame, and re-encode the video frame in accordance with the selected QP value at the lower second bitrate. Video recompression unit 12 then stores the video frame recompressed at the second bitrate in system memory 10.

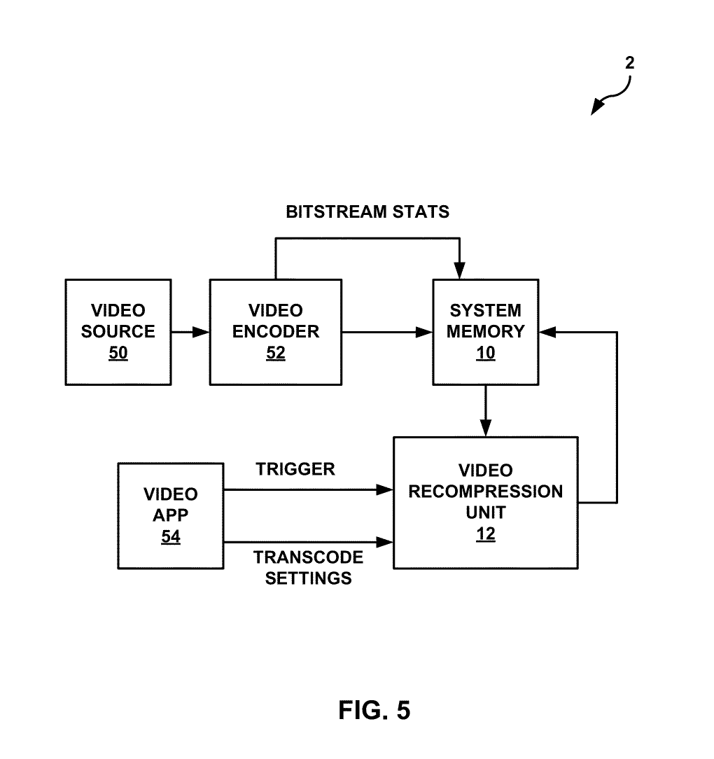

FIG. 5 is a block diagram illustrating an example use case of video recompression for video sharing performed by video recompression unit 12 of computing device 2 from FIG. 1. In the video sharing use case illustrated in FIG. 5, the video recompression techniques of this disclosure work in conjunction with video transcoding based on transcode settings for a video sharing application executed on computing device 2. Video recompression unit 12 of computing device 2 may be configured to transcode and recompress a video frame originally encoded at a higher first bitrate to a lower second bitrate for storage and later sharing, uploading, or streaming via the video sharing application.

In the example illustrated in FIG. 5, a video encoder 52 receives raw video frames from a video source 50, encodes the video frames at the higher first bitrate, and stores the video frames in system memory 10. Video encoder 52 may also store bitstream statistics associated with the encoded video frames in system memory 10. In some examples, video encoder 52 may comprise an encoder portion of video processor 23 of computing device 2. Video source 50 may comprise camera 21 of computing device 2 or an external camera.

According to the disclosed techniques, transcode and recompression of the video frame may be triggered by a user requesting to share, upload, or stream a stored video file using a video sharing application (“video app”) 54 executed on computing device 2. Video app 54 may provide transcode settings to video recompression unit 12 that indicate one or more of a resolution, frame rate (e.g., fps), or target bitrate for video clips to be shared, uploaded, or streamed via video app 54. Upon identifying the trigger condition and receiving the transcode settings, video recompression unit 12 obtains a video frame to be transcoded and recompressed.

Video recompression unit 12 may be configured to decode the video frame encoded at the first bitrate, modify settings of the video frame according to the transcode settings received from video app 54, select a new QP value at which to recompress the video frame such that the recompressed video frame is nearly visually lossless compared to transcoded content of the video frame, and re-encode the video frame at the modified settings in accordance with the selected QP value at the lower second bitrate. Video recompression unit 12 then stores the transcoded video frame recompressed at the second bitrate in system memory 10.

In some examples, the second bitrate may be lower than both the first bitrate and lower than or equal to a target bitrate specified by the transcode settings for the video sharing application. In addition, the transcoded and recompressed video frame may be near visually lossless compared to the transcoded content of the video frame depending on the target bitrate. In this case, the transcoded content is the raw content generated after the video frame is decoded and transcoded to the resolution and frame rate specified by the transcode settings for the video sharing application.

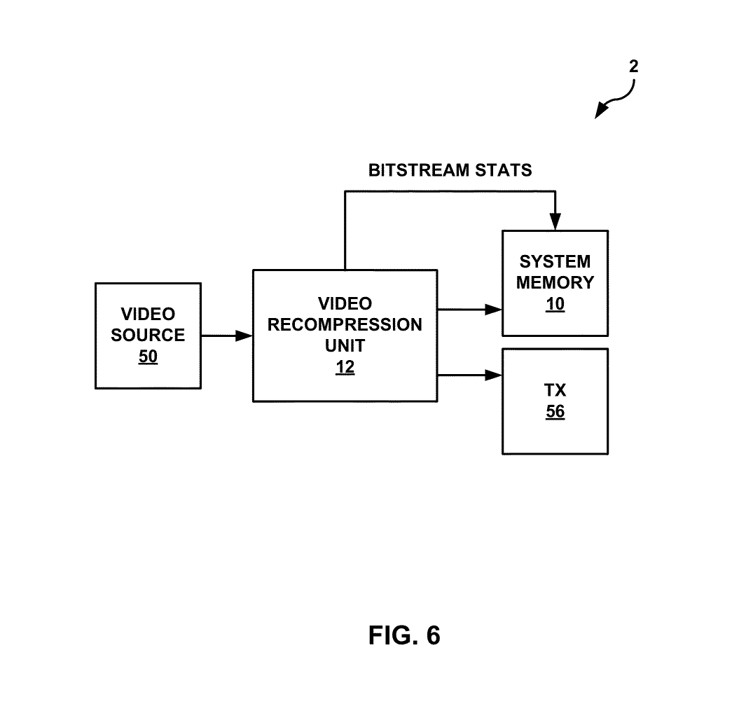

FIG. 6 is a block diagram illustrating an example use case of video recompression for live video recordings performed by video recompression unit 12 of computing device 2 from FIG. 1. In the live recordings use case illustrated in FIG. 6, video recompression unit 12 of computing device 2 may be configured to compress a video frame of a live recording at a first bitrate to a lower second bitrate for storage and/or transmission. In some cases, video recompression unit 12 may generate two compressed versions of the video frame, one at the lower second bitrate for storage and another at an even lower third bitrate for transmission.

In the example illustrated in FIG. 6, video recompression unit 12 receives raw video frames at the higher first bitrate directly from a video source 50. In accordance with the disclosed techniques, video recompression unit 12 may perform compression of the raw video frames prior to either storage in system memory 10 or transmission by transmitter (“TX”) 56 of computing device 2. Video recompression unit 12 may also store bitstream statistics associated with the encoded video frames in system memory 10. Video source 50 may comprise camera 21 of computing device 2 or an external camera.

As described above, video recompression unit 12 may be configured to select a QP value at which to compress a video frame of the live recording such that the compressed video frame is nearly visually lossless compared to the original video frame, and encode the video frame in accordance with the selected QP value at the lower second bitrate. In one example, video recompression unit 12 then stores the video frame compressed at the second bitrate in system memory 10. The second bitrate may be 30-70% lower than the first bitrate. In another example, video recompression unit 12 sends the video frame compressed at the second bitrate to TX 56 for transmission, e.g., video sharing, uploading, or streaming.

In a further example, the recompression techniques of this disclosure may be applied to compress a video frame of the live recording for storage at the lower second bitrate and to compress the same video frame for transmission at an even lower third bitrate. To generate the video frame for transmission, video recompression unit 12 may modify settings of the original video frame according to transcode settings for video sharing, uploading, or streaming. For example, video recompression unit 12 may modify one or more of a resolution, frame rate (e.g., fps), or target bitrate of the video frame. Video recompression unit 12 may be configured to select a QP value at which to compress the video frame such that the compressed video frame is nearly visually lossless compared to modified content of the video frame, and encode the video frame at the modified settings in accordance with the selected QP value at the lower third bitrate. Video recompression unit 12 then sends the video frame compressed at the third bitrate to TX 56 for transmission, e.g., video sharing, uploading, or streaming. In some examples, the third bitrate may be lower than the first bitrate and the second bitrate, and lower than or equal to a target bitrate specified by the transcode settings.

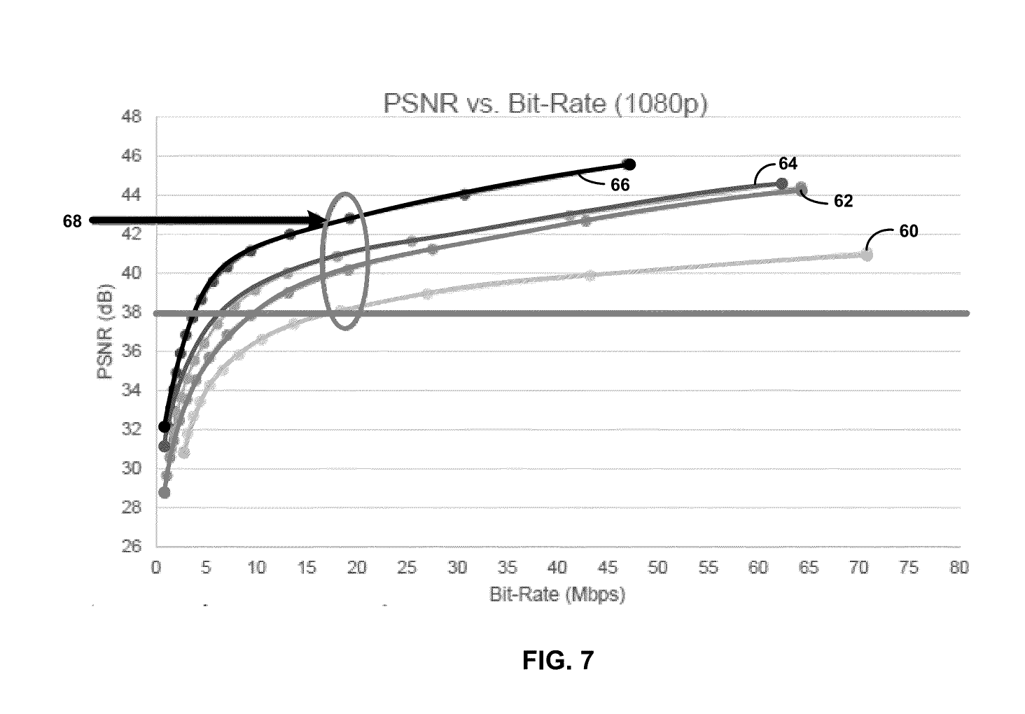

FIG. 7 is a graph illustrating example rate-distortion curves for different video clips having different quality levels at a given bitrate. In FIG. 7, RD curves are illustrated for video clips 60, 62, 64 and 66 recorded at 1080p. As can be seen, video clip 66 has higher quality (i.e., peak signal-to-noise ratio (PSNR) at lower bitrates than the other video clips. For example, as indicated by ellipse 68, video clips 60, 62, 64 and 66 have respective quality levels ranging from 38 dB to 43 dB at a bitrate of 20 mbps.

Typically, encoder bitrates are set to ensure that the most complex video clips achieve good video quality. In the example illustrated by FIG. 7, if good video quality is assumed to be 38 dB, then the encoder bitrate may be set to 20 mops to ensure that all of video clips 60, 62, 64 and 66 achieve the good video quality level. As can be seen, however, video clips 60, 62, 64 and 66 may be encoded at lower bitrates while still achieving the good video quality level of 38 dB.

The techniques of this disclosure determine an amount of bitrate reduction that is possible for each video clip using a visually lossless threshold. The amount of bitrate reduction is dependent on the content of the given video clip. For example, to achieve video quality of 38 dB, video clip 60 may be recompressed at a bitrate of 18 mhps for a 10% bitrate reduction, video clip 62 may be recompressed at a bitrate of 10 mbps for a 50% bitrate reduction, video clip 64 may be recompressed at a bitrate of 7 mbps for a 65% bitrate reduction, and video clip 66 may be recompressed at a bitrate of 3 mops for a 85% bitrate reduction.

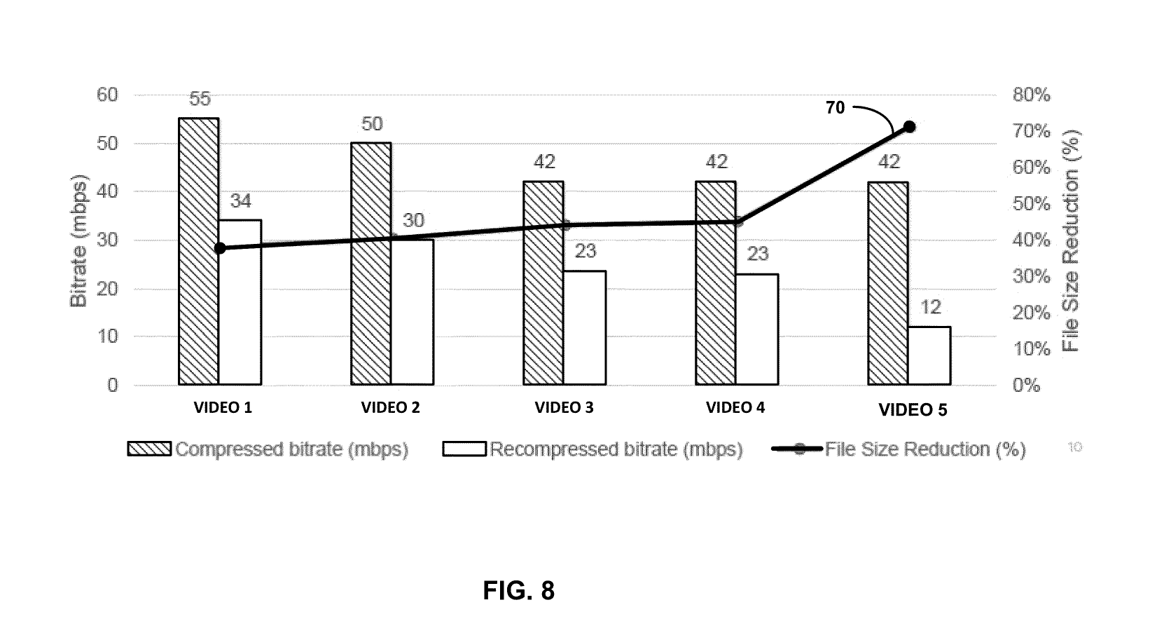

FIG. 8 is a graph illustrating example performance levels of the video recompression techniques described in this disclosure. In FIG. 8, the compressed bitrates for original video clips 1-5 are illustrated as diagonal stripped boxes, and the recompressed bitrates for video clips 1-5 recompressed according to the disclosed techniques are illustrated as white boxes. In addition, a file size reduction percentage 70 achieved by the disclosed techniques is plotted for each of video clips 1-5. As can be seen, the file size reduction percentage 70 of the disclosed techniques ranges from 30% to more than 70% depending on the content of video clips 1-5. Video clips 1-5 may be recorded at 4K30 at half-speed, or 1080p30 in real time.

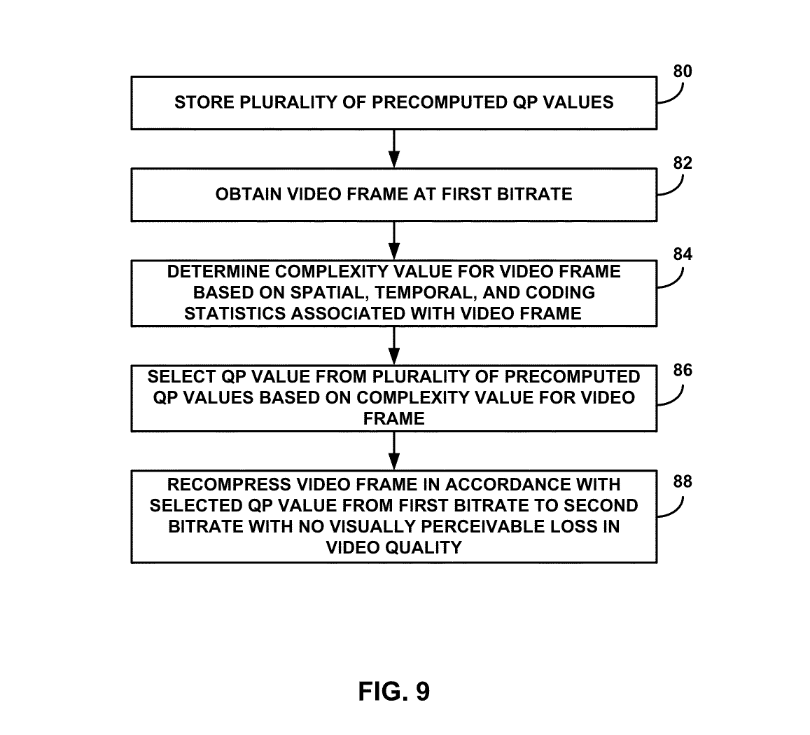

FIG. 9 is a flowchart illustrating an example operation of the video recompression techniques described in this disclosure. The example operation of FIG. 9 is described with respect to video recompression unit 12 from FIG. 2.

In general, video recompression unit 12 may recompress a video frame for one or more of storage in system memory 10 of computing device 2 or transmission (e.g., video sharing, uploading, or streaming) by computing device 2. In one example, video recompression unit 12 may recompress the video frame for storage to reduce memory consumption. For example, a video frame encoded at a first bitrate may be stored in system memory 10 having a first file size, and the video frame recompressed at a second bitrate may be stored in system memory 10 having a second file size that is smaller than the first file size. In another example, video recompression unit 12 may recompress the video frame for transmission to reduce power consumption during video sharing, uploading, or streaming.

According to the techniques of this disclosure, video recompression unit 12 initially stores a plurality of precomputed QP values (80). The precomputed QP values may be stored as REC model 36. In some examples, REC model 36 may comprise a delta QP lookup table (LUT) indexed by a complexity value for a video frame at a given QP value. In other examples, REC model 36 may comprise a function that returns a delta QP value based on a complexity value, e.g., a REC value, for a video frame at a given QP value. In either format, the precomputed QP values may be stored in system memory 10 of computing device 2. As described above with respect to FIG. 3, the plurality of precomputed QP values may be precomputed based on a database of video clips and a quality metric to determine maximum QP values used to recompress each of the video clips that result in no visually perceivable loss in video quality.

In operation, video recompression unit 12 obtains a video frame at a first bitrate (82). In one example, video recompression unit 12 may retrieve the video frame encoded at the first bitrate from system memory 10. For example, computing device 2 may store the video frame encoded at the first bitrate to system memory 10. Video recompression unit 12 may identify a trigger condition for recompression of the video frame, and, responsive to identifying the trigger condition, retrieve the video frame encoded at the first bitrate from system memory 10 for recompression of the video frame.

The trigger condition may comprise a characteristic of the computing device 2, such as expiration of a preset or periodic timer, upon detection of low usage times (e.g., overnight), or upon detection that computing device 2 is plugged in. The trigger condition may also comprise a user input to the device, such as a user explicitly selecting when to perform recompression, or a user requesting to share, upload, or stream the video frame using a certain application or “app” executed on computing device 2.

In another example, video recompression unit 12 may obtain the video frame directly from a live video recording. For example, computing device 2 may receive a sequence of raw video frames from camera 21 of computing device 2 or from an external camera. Video processor 23 of computing device 2 may then send the sequence of raw video frames at the first bitrate directly to video recompression unit 12 for compression of the video frame.

Upon obtaining the video frame at the first bitrate, video recompression unit 12 determines a complexity value, e.g., a REC value, for the video frame based on spatial, temporal, and coding statistics associated with the video frame (84). For example, QP selection unit 32 of video recompression unit 12 may determine the REC value for the video frame based on scene statistics (e.g., YUV statistics) associated with the video frame and bitstream statistics associated with a previously encoded video frame.

Video recompression unit 12 then selects a QP value from the plurality of precomputed QP values based on the complexity value (e.g., the REC value) for the video frame (86). For example, QP selection unit 32 may select a delta QP value from REC model 36 formatted as a lookup table indexed by the complexity value for the video frame at a previous QP value for the video frame. QP selection unit 32 then calculates the new QP value for the video frame based on the delta QP value and the previous QP value.

The plurality of precomputed QP values enable QP selection unit 32 to select the QP value for the video frame in one step. In this way, QP selection unit 32 avoids performing multiple iterations of selecting a new QP value for a video frame. By performing QP selection, and hence video frame recompression, in one step, the techniques of this disclosure may reduce a computational burden and/or amount of power consumption of video recompression unit 12 in computing device 2.

Video recompression unit 12 then recompresses the video frame in accordance with the selected QP value from the first bitrate to a second bitrate with no visually perceivable loss in video quality, the second bitrate being lower than the first bitrate (88). In one example, decoder 30 of video recompression unit 12 first decodes the video frame encoded at the first bitrate, and encoder 34 of video recompression unit 12 re-encodes the video frame in accordance with the selected QP value at the second bitrate. In this example, QP selection unit 32 may determine the complexity value (e.g., the REC value) based on scene statistics of the decoded video frame received from decoder 30 and bitstream statistics of a previously encoded video frame received from encoder 34. QP selection unit 32 then selects the QP value for the video frame based on the determined complexity value.

In another example, decoder 30 of video recompression unit 12 first decodes the video frame encoded at the first bitrate, QP selection unit 32 modifies settings of the video frame, and encoder 34 of video recompression unit 12 re-encodes the video frame at the modified settings in accordance with the selected QP value at the second bitrate

In this example, QP selection unit 32 may again determine the complexity value (e.g., the REC value) based on scene statistics of the decoded video frame received from decoder 30 and bitstream statistics of a previously encoded video frame received from encoder 34, and then select the QP value for the video frame based on the determined complexity value. In addition, QP selection unit 32 may modify one or more of a resolution, frame rate, or target bitrate of the video frame in order to transcode the decoded video frame. Performing recompression in combination with transcoding the video frame may be especially useful when preparing the video frame for sharing, uploading, or streaming using a certain application or “app” executed on computing device 2.

In a further example, video recompression unit 12 performs a first compression of the video frame from the first bitrate to the second bitrate for storage of the video frame in system memory 10, and also performs a second compression of the video frame from the first bitrate to a third bitrate for transmission of the video frame, the third bitrate being lower than the first bitrate. In some cases, the third bitrate may also be lower than the second bitrate. In this case, the video frame may be stored at the second bitrate with no visually perceivable loss in video quality compared to the original video frame at the first bitrate. In addition, the video frame may be transmitted at the third bitrate with no visually perceivable loss in video quality compared to a modified or transcoded video frame for sharing, uploading, or streaming.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless communication device, a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method of processing video data, the method comprising:
storing a plurality of precomputed quantization parameter (QP) values, wherein the plurality of precomputed QP values are precomputed based on a database of video clips and a quality metric to determine maximum QP values used to recompress each of the video clips that result in no visually perceivable loss in video quality;
obtaining a video frame at a first bitrate;
determining a complexity value for the video frame based on spatial, oral, and coding statistics associated with the video frame;
selecting a QP value from the plurality of precomputed QP values based on the complexity value for the video frame; and
recompressing the video frame in accordance with the selected QP value from the first bitrate to a second bitrate with no visually perceivable loss in video quality, the second bitrate being lower than the first bitrate.

2. The method of claim 1, further comprising storing the video frame encoded at the first bitrate to a memory of a device, wherein obtaining the video frame comprises:
identifying a trigger condition for recompression of the video frame, wherein the trigger condition comprises at least one of a characteristic of the device or a user input to the device; and
responsive to identifying the trigger condition, retrieving the video frame at the first bitrate from the memory for recompression of the video frame.

3. The method of claim 1, wherein obtaining the video frame comprises receiving a sequence of raw video frames from a camera at the first bitrate.

4. The method of claim 1, wherein obtaining the video frame comprises retrieving the video frame encoded at the first bitrate from a memory, the encoded video frame having a first file size, the method further comprising:
storing the video frame recompressed at the second bitrate to the memory, the recompressed video frame having a second file size that is smaller than the first file size.

5. The method of claim 1, wherein recompressing the video frame from the first bitrate to the second bitrate comprises performing a first recompression of the video frame for storage of the video frame, the method further comprising:
performing a second recompression of the video frame from the first bitrate to a third bitrate for transmission of the video frame, the third bitrate being lower than the first bitrate.

6. The method of claim 1, wherein recompressing the video frame comprises:
decoding the video frame encoded at the first bitrate; and
re-encoding the video frame in accordance with the selected QP value at the second bitrate.

7. The method of claim 1, wherein recompressing the video frame comprises:
decoding the video frame encoded at the first bitrate;
modifying settings of the video frame, the settings including one or more of a resolution, frame rate, or target bitrate of the video frame; and
re-encoding the video frame at the modified settings in accordance with the selected QP value at the second bitrate.

8. The method of claim 1, wherein selecting the QP value from the plurality of precomputed QP values comprises:
selecting a delta QP value from a lookup table indexed by the complexity value for the video frame; and
calculating the QP value based on the delta QP value and a previous QP value for the video frame encoded at the first bitrate.

9. The method of claim 1, wherein determining the complexity value for the video frame comprises determining a re-encode complexity (REC) value based on scene statistics associated with the video frame and bitstream statistics associated with a previously encoded video frame.

10. The method of claim 1, wherein selecting the QP value comprises selecting the QP value in one step.

11. A video processing device, the device comprising:
a memory configured to store a plurality of precomputed quantization parameter (QP) values, wherein the plurality of precomputed QP values are precomputed based on a database of video clips and a quality metric to determine maximum QP values used to recompress each of the video clips that result in no visually perceivable loss in video quality; and
one or more processors in communication with the memory and configured to:
obtain a video frame at a first bitrate;
determine a complexity value for the video frame based on spatial, temporal, and coding statistics associated with the video frame;
select a QP value from the plurality of precomputed QP values based on the complexity value for the video frame; and
recompress the video frame in accordance with the selected QP value from the first bitrate to a second bitrate with no visually perceivable loss in video quality, the second bitrate being lower than the first bitrate.

12. The device of claim 11, wherein the one or more processors are configured to:
store the video frame encoded at the first bitrate to the memory;
identify a trigger condition for recompression of the video frame, wherein the trigger condition comprises at least one of a characteristic of the device or a user input to the device; and
responsive to identifying the trigger condition, retrieve the video frame encoded at the first bitrate from the memory for recompression of the video frame.

13. The device of claim 11, wherein the one or more processors are configured to receive a sequence of raw video frames from a camera at the first bitrate.

14. The device of claim 11, wherein the one or more processors are configured to:
retrieve the video frame encoded at the first bitrate from the memory, the encoded video frame having a first file size; and
store the video frame recompressed at the second bitrate to the memory, the recompressed video frame having a second file size that is smaller than the first file size.

15. The device of claim 11, wherein the one or more processors are configured to:
perform a first recompression of the video frame from the first bitrate to the second bitrate for storage of the video frame; and
perform a second recompression of the video frame from the first bitrate to a third bitrate for transmission of the video frame, the third bitrate being lower than the first bitrate.

16. The device of claim 11, wherein, to recompress the video frame, the one or more processors are configured to:
decode the video frame encoded at the first bitrate; and
re-encode the video frame in accordance with the selected QP value at the second bitrate.

17. The device of claim 11, wherein, to recompress the video frame, the one or more processors are configured to:
decode the video frame encoded at the first bitrate;
modify settings of the video frame, the settings including one or more of a resolution, frame rate, or target bitrate of the video frame; and
re-encode the video frame at the modified settings in accordance with the selected QP value at the second bitrate.

18. The device of claim 11, wherein, to select the QP value from the plurality of precomputed QP values, the one or more processors are configured to:
select a delta QP value from a lookup table indexed by the complexity value for the video frame; and
calculate the QP value based on the delta QP value and a previous QP value for the video frame at the first bitrate.

19. The device of claim 11, wherein, to determine the complexity value for the video frame, the one or more processors are configured to determine a re-encode complexity (REC) value based on scene statistics associated with the video frame and bitstream statistics associated with a previously encoded video frame.

20. The device of claim 11, wherein the one or more processors are configured to select the QP value in one step.

21. The device of claim 11, wherein the device comprises at least one of:
an integrated circuit;
a microprocessor; or
a wireless communication device.

22. The device of claim 11, wherein the device comprises a camera configured to capture a sequence of raw video frames.

23. A video processing device, the device comprising:
means for storing a plurality of precomputed quantization parameter (QP) values, wherein the plurality of precomputed. QP values are precomputed based on a database of video clips and a quality metric to determine maximum QP values used to recompress each of the video clips that result in no visually perceivable loss in video quality;
means for obtaining a video frame at a first bitrate;
means for determining a complexity value for the video frame based on spatial, temporal, and coding statistics associated with the video frame;
means for selecting a QP value from the plurality of precomputed QP values based on the complexity value for the video frame; and
means for recompressing the video frame in accordance with the selected QP value from the first bitrate to a second bitrate with no visually perceivable loss in video quality, the second bitrate being lower than the first bitrate.

24. The device of claim 23, wherein the means for recompressing the video frame comprise:
means for decoding the video frame encoded at the first bitrate; and
means for re-encoding the video frame in accordance with e selected QP value at the second bitrate.

25. The device of claim 23, wherein the means for selecting the QP value from the plurality of precomputed QP values comprise:
means for selecting a delta QP value from a lookup table indexed by the complexity value for the video frame; and
means for calculating the QP value based on the delta QP value and a previous QP value for the video frame at the first bitrate.

26. The device of claim 23, wherein the means for determining the complexity value for the video frame comprise means for determining a re-encode complexity (REC) value based on scene statistics associated with the video frame and bitstream statistics associated with a previously encoded video frame.

27. A non-transitory computer-readable medium storing instructions that, when executed, cause one or more processors to:
store a plurality of precomputed quantization parameter (QP) values, wherein the plurality of precomputed QP values are precomputed based on a database of video clips and a quality metric to determine maximum QP values used to recompress each of the video clips that result in no visually perceivable loss in video quality;
obtain a video frame at a first bitrate;
determine a complexity value for the video frame based on spatial, temporal,and coding statistics associated with the video frame;
select a QP value from the plurality of precomputed QP values based on the complexity value for the video frame; and
recompress the video frame in accordance with the selected QP value from the first bitrate to a second bitrate with no visually perceivable loss in video quality, the second bitrate being lower than the first bitrate.

28. The non-transitory computer-readable medium of claim 27, wherein the instructions that cause the one or more processors to recompress the video frame further cause the one or more processors to:
decode the video frame encoded at the first bitrate; and
re-encode the video frame in accordance with the selected QP value at the second bitrate.

29. The non--transitory computer-readable medium of claim 27, wherein the instructions that cause the one or more processors to select the QP value from the plurality of precomputed QP values further cause the one or more processors to:
select a delta QP value from a lookup table indexed by the complexity value for the video frame; and
calculate the QP value based on the delta QP value and a previous QP value for the video frame at the first bitrate.

30. The non-transitory computer-readable medium of claim 27, wherein the instructions that cause the one or more processors to determine the complexity value for the video frame further cause the one or more processors to determine a re-encode complexity (REC) value based on scene statistics associated with the video frame and bitstream statistics associated with a previously encoded video frame.
